(19) United States
(12) Patent Application Publication
(10) Pub. No.: US 2010/0127176 A1
(43) Pub. Date: May 27, 2010

(54) SCINTILLATOR MATERIALS WHICH ABSORB HIGH-ENERGY, AND RELATED METHODS AND DEVICES

(75) Inventor: Alok Mani Srivastava, Niskayuna, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/275,272

(22) Filed: Nov. 21, 2008

(51) Int. Cl. G01T 1/20

(52) U.S. Cl. 250/362; 250/367

(57) ABSTRACT

A scintillator composition is described, including a lutetium silicate or lutetium phosphate matrix; along with selected amounts of cerium, praseodymium, and gadolinium. A radiation detector for detecting high-energy radiation is also described. The radiation detector incorporates a crystal scintillator having the composition mentioned above. Related methods for detecting high-energy radiation with a scintillation detector are also disclosed herein.

### BACKGROUND OF THE INVENTION

This invention relates to materials useful for ionizing radiation detection devices, e.g., luminescent materials. In some specific embodiments, the invention is directed to scintillator compositions which are especially useful for detecting gamma-rays and X-rays under a variety of conditions. Scintillators are materials that emit flashes or pulses of light when they interact with ionizing radiation such as gamma rays.

Since high energy ionizing radiation such as gamma radiation cannot be detected directly; it must be converted into an electrical pulse. One common method for creating an electrical pulse when ionizing radiation is present is to first absorb the ionizing radiation in a scintillator. In response, the scintillator then produces a flash of light.

The effectiveness of this method of high energy radiation detection is primarily limited by the scintillating material. (Scintillator compositions usually include a matrix material, along with at least one dopant or “activator” for the matrix, such as cerium (Ce) or praseodymium (Pr)). A limited number of materials are known to scintillate, and the scintillation properties of these materials vary.

An ideal scintillator for some applications would have a high density, a short decay time constant (i.e. the photons are emitted as soon as possible after the radiation interacts in the scintillator), and a large light output that is essentially proportional to the amount of high energy radiation deposited in the scintillator. High density is desirable in order to stop the ionizing radiation in as short a distance as possible. A short decay time is desirable in order to measure the time of interaction accurately. A high light output is desirable in order to make it easier for the radiation detector to convert the light into an electrical pulse whose size indicates the amount of energy of radiation. In addition, the scintillating materials usually should not have unpleasant chemical or material properties, such as toxicity, hygroscopy, or extreme reactivity. Moreover, it is advantageous to utilize a material that is readily fabricated in crystal form.

Various scintillator materials which possess most or all of these properties have been in use over the years. Examples include thallium-activated sodium iodide (NaI(Tl)); bismuth germanate (BGO); cerium-doped gadolinium orthosilicate (GSO); cerium-doped lutetium orthosilicate (LSO); and cerium-activated lanthanide-halide compounds. Each of these materials has properties which are very suitable for certain applications, such as imaging devices. However, many of them also have some drawbacks, alluded to above. For example, the thallium-activated materials are very hygroscopic, and can also produce a large and persistent after-glow, which can interfere with scintillator function. Moreover, the BGO materials frequently have a slow decay time. On the other hand, the LSO materials are expensive, and may also contain radioactive lutetium isotopes which can also interfere with scintillator function.

Those interested in obtaining the optimum scintillator composition for a radiation detector have usually been able to review the various attributes set forth above, and thereby select the best composition for a particular device. (As an illustration, scintillator compositions for well-logging applications must be able to function at high temperatures, while scintillators for positron emission tomography (PET) devices must often exhibit high stopping power). However, the required overall performance level for most scintillators continues to rise with the increasing sophistication and diversity of all radiation detectors.

With these considerations in mind, new scintillator materials would be of considerable interest, if they could satisfy the ever-increasing demands for commercial and industrial use. The materials should exhibit excellent light output. They should also possess one or more other desirable characteristics, such as relatively fast decay times and good energy resolution characteristics, especially in the case of gamma rays. Furthermore, they should be capable of being produced efficiently, at reasonable cost and acceptable crystal size.

### BRIEF DESCRIPTION OF THE INVENTION

One embodiment of the present invention is directed to a scintillator composition, comprising the following, and any reaction products thereof:
(a) a matrix comprising at least one lutetium silicate or lutetium phosphate compound;
(b) cerium;
(c) praseodymium; and
(d) gadolinium.

Another embodiment is directed to a radiation detector for detecting high-energy radiation. The radiation detector incorporates a crystal scintillator which comprises the composition recited above, and described in the remainder of the specification.

Another embodiment relates to a method for detecting high-energy radiation with a scintillation detector. The method comprises the following steps:
(A) receiving radiation by a scintillator crystal, so as to produce photons which are characteristic of the radiation; and
(B) detecting the photons with a photon detector coupled to the scintillator crystal. The scintillator crystal comprises the components recited above.

### BRIEF DESCRIPTION OF THE DRAWINGS

FIG. 1 is a depiction of an energy band diagram for a combination of cerium, praseodymium, and gadolinium activators.

FIG. 2 is a graph of emission spectra for comparative scintillator compositions, under X-Ray excitation.

### DETAILED DESCRIPTION OF THE INVENTION

Component (a) for the scintillator composition comprises at least one lutetium silicate or lutetium phosphate compound. (As those skilled in the art understand, this portion of the scintillator composition is sometimes referred to as the “matrix”, although the present inventors do not wish to be bound by any limitations associated with that term). A variety of materials can be used as the “silicate” in the first-mentioned compound. Some of them are described in U.S. Pat. No. 5,140,163 (Tecotzky), which is incorporated herein by reference. They include the pyrosilicate (Si₂O₇)⁶⁻ and orthosilicate (SiO₄)⁴⁻ anions, as well as various combinations thereof. In some preferred embodiments, the pyrosilicate materials are preferred, e.g., lutetium pyrosilicate (Lu₂Si₂O₇). Pyrosilicates are described, for example, by P. Szupryczynski et al, in an article entitled “Ce-Doped Lutetium Pyrosilicate Scintillators LPS and LYPS”, 2005 IEEE Nuclear Science Symposium Conference Record, pages 1310-1313.

In other embodiments, lutetium phosphate compounds are preferred. The compounds may be based on various phosphate salts. (For example, various phosphate ions upon which some types of lanthanide phosphate compounds are based are described in U.S. Pat. No. 5,057,627 (Edwards), which is incorporated herein by reference). A specific example of a suitable lutetium phosphate compound is LuPO₄.

Moreover, in some embodiments, a portion of the lutetium in component (a) can be substituted with one or more other lanthanides. Examples of the other lanthanides are lanthanum, yttrium, gadolinium, terbium, scandium, europium, and mixtures thereof. In some preferred embodiments, the amount of lutetium replaced by one or more of the other lanthanides is up to a maximum (total) of about 20 mole percent, based on total moles of component (a).

The scintillator composition further comprises cerium and praseodymium. Those skilled in the art understand that these components are sometimes referred to as activators or “dopants”. Each is usually employed in its trivalent state, Ce⁺³ and Pr⁺³. Moreover, they can be supplied in various forms, e.g., halides like cerium chloride or cerium bromide.

Another component of the scintillator composition is gadolinium. As further described below, it is believed that the gadolinium may function as an intermediate during activation of the scintillator composition, transferring energy from the Pr⁺³ ion to the Ce⁺³ ion. The amount of gadolinium present will depend on various factors, such as the specific composition of the matrix; the levels of the other activators; and the requirements for properties such as light output and energy resolution. The level of gadolinium is usually in the range of about 0.01 mole percent to about 15 mole percent, based on the total number of moles of the activator ions and the matrix material. In some specific embodiments, the amount of gadolinium present is in the range of about 0.01 mole percent to about 10 mole percent. Moreover, in embodiments which are preferred for certain end uses, e.g., some of the medical imaging devices, the level of gadolinium is often in the range of about 0.1 mole percent to about 2 mole percent. The gadolinium is usually employed in the +3 oxidation state; and can be supplied in various forms, e.g., as a fluoride, chloride, or bromide.

In a similar manner, the respective, individual levels of cerium and praseodymium can be expressed. Thus, the amount of cerium present in the scintillator composition is usually in the range of about 0.01 mole percent to about 20 mole percent, based on the total number of moles of the activator ions and the matrix material; and preferably, in the range of about 0.01 mole percent to about 5 mole percent. The amount of praseodymium which is present in the scintillator composition is usually in the range of about 0.01 mole percent to about 20 mole percent, based on the total number of moles of the activator ions and the matrix material, and preferably, in the range of about 0.01 mole percent to about 5 mole percent.

Those skilled in the art will be able to select the most appropriate levels of each of Ce, Pr, and Gd, based in part on the overall requirements for the scintillator composition; as well as the teachings herein. The total amount of activator (i.e., Ce, Pr, and Gd) is usually in the range of about 0.01 mole percent to about 20 mole percent, based on total moles of activator and matrix compounds. In some preferred embodiments, the total amount of activator is in the range of about 1 mole percent to about 10 mole percent. Moreover, it should be understood that when all of the components are combined, they can be considered as a single, intimately-mixed scintillator composition, which still retains the attributes of both a “matrix” and an activator system.

The scintillator composition of this invention may be prepared and used in various forms. In some preferred embodiments, the composition is in monocrystalline (i.e., “single crystal”) form. Monocrystalline scintillator crystals have a greater tendency for transparency. They are especially useful for high-energy radiation detectors, e.g., those used for gamma rays.

However, other forms of the scintillator composition are also possible, depending on its intended end use. For example, it can be in powder form. It should also be understood that the scintillator compositions may contain small amounts of impurities, as described in the previously-referenced publications, WO 01/60944 A2 and WO 01/60945 A2 (incorporated herein by reference). These impurities usually originate with the starting materials, and typically constitute less than about 0.1% by weight of the scintillator composition. Very often, they constitute less than about 0.01% by weight of the composition. The composition may also include parasitic additives, whose volume percentage is usually less than about 1%. Moreover, minor amounts of other materials may be purposefully included in the scintillator compositions.

In some (though not all) embodiments, the scintillator compositions are substantially free of lanthanum. Lanthanum may contain a small amount of one or more long-decay, radioactive isotopes. These isotopes result in a background count rate that can interfere with sensitive detector applications.

A variety of techniques can be used for the preparation of the scintillator compositions. (It should be understood that the compositions may also contain a variety of reaction products of these techniques). Usually, a suitable powder containing the desired materials in the correct proportions is first prepared, followed by such operations as calcination, die forming, sintering, and/or hot isostatic pressing. The powder can be prepared by mixing various forms of the reactants (e.g., salts, halides, oxides, or mixtures thereof). In some cases, individual constituents are used in combined form. (They may be commercially available in that form, for example).

The mixing of the reactants can be carried out by any suitable techniques which ensure thorough, uniform blending. For example, mixing can be carried out in an agate mortar and pestle. Alternatively, a blender or pulverization apparatus can be used, such as a ball mill, a bowl mill, a hammer mill, or a jet mill. Conventional precautions usually must be taken to prevent the introduction of any air or moisture during mixing. The mixture can also contain various additives, such as fluxing compounds and binders. Depending on compatibility and/or solubility, various liquids can sometimes be used as a vehicle during milling. Suitable milling media should be used, e.g., material that would not be contaminating to the scintillator, since such contamination could reduce its light-emitting capability.

After being blended, the mixture can then be fired under temperature and time conditions sufficient to convert the mixture into a solid solution. These conditions will depend in part on the specific type of matrix material and activator being used. The mixture is usually contained in a sealed vessel (e.g., a tube or crucible made of quartz or silver) during firing, so that none of the constituents are lost to the atmosphere). Usually, firing will be carried out in a furnace, at a temperature in the range of about 1000° C. to about 1500° C. The firing time will typically range from about 15 minutes to about 10 hours. Firing is usually carried out in an atmosphere free of oxygen and moisture, e.g., in a vacuum, or using an inert gas such as nitrogen, helium, neon, argon, krypton, and xenon. (In some instances, firing can be carried out in a reducing atmosphere.) After firing is complete, the resulting material can be pulverized, to put the scintillator into powder form. Conventional techniques can then be used to process the powder into radiation detector elements.

In the case of single crystal materials, specific preparation techniques are also well-known in the art. A non-limiting, exemplary reference is “Luminescent Materials”, by G. Blasse et al, Springer-Verlag (1994). Usually, the appropriate reactants are melted at a temperature sufficient to form a congruent, molten composition. The melting temperature will depend on the identity of the reactants themselves, but is usually greater than about 1500° C.

Another embodiment of the invention is directed to a method for detecting high-energy radiation with a scintillation detector. The detector includes one or more crystals, formed from the scintillator composition described herein. Scintillation detectors are well-known in the art, and need not be described in detail here. Several references (of many) which discuss such devices are U.S. Pat. Nos. 6,585,913 and 6,437,336, mentioned above, and U.S. Pat. No. 6,624,420 (Chai et al), which is also incorporated herein by reference.

In general, the scintillator crystals in these devices receive radiation from a source being investigated, and produce photons which are characteristic of the radiation. The photons are detected with some type of photodetector (“photon detector”). (The photodetector is connected to the scintillator crystal by conventional electronic and mechanical attachment systems). The photodetector can be a variety of devices, all well-known in the art. Non-limiting examples include photomultiplier tubes, photodiodes, CCD sensors, and image intensifiers. Choice of a particular photodetector will depend in part on the type of radiation detector being fabricated, and on its intended use.

As mentioned previously, various tools and devices can be connected to the radiation detectors (which include the scintillator and the photodetector). Non-limiting examples of the devices include well-logging tools and nuclear medicine devices (e.g., PET). The radiation detectors may also be connected to digital imaging equipment, e.g., pixilated flat panel devices. Moreover, the scintillator may serve as a component of a screen scintillator. For example, powdered scintillator material could be formed into a relatively flat plate which is attached to a film, e.g., photographic film. High energy radiation, e.g., X-rays, originating from some source, would contact the scintillator and be converted into light photons which are developed on the film. Furthermore, the radiation detectors may also be used for security devices. For example, they could be used to detect the presence of radioactive materials in cargo containers.

Several of the specific end use applications can be described here in more detail, although many of the relevant details are known to those skilled in the art. Well-logging devices were mentioned previously, and represent an important application for these radiation detectors. The technology for operably connecting the radiation detector to a well-logging tube is well-understood. The general concepts are described in U.S. Pat. No. 5,869,836 (Linden et al), which is incorporated herein by reference. The crystal package containing the scintillator usually includes an optical window at one end of the enclosure-casing. The window permits radiation-induced scintillation light to pass out of the crystal package for measurement by the light-sensing device (e.g., the photomultiplier tube), which is coupled to the package. The light-sensing device converts the light photons emitted from the crystal into electrical pulses that are shaped and digitized by the associated electronics. By this general process, gamma rays can be detected, which in turn provides an analysis of the rock strata surrounding the drilling bore holes. It should be emphasized, however, that many variations of well-logging devices are possible.

As also mentioned previously, another important application for the radiation detectors is in medical imaging equipment, such as the PET devices mentioned above. The technology for operably connecting the radiation detector (containing the scintillator) to a PET device is well-known in the art. The general concepts are described in many references, such as U.S. Pat. No. 6,624,422 (Williams et al), incorporated herein by reference. In brief, a radiopharmaceutical is usually injected into a patient, and becomes concentrated within an organ of interest. Radionuclides from the compound decay and emit positrons. When the positrons encounter electrons, they are annihilated and converted into photons, or gamma rays. The PET scanner can locate these “annihilations” in three dimensions, and thereby reconstruct the shape of the organ of interest for observation. The detector modules in the scanner usually include a number of “detector blocks”, along with the associated circuitry. Each detector block may contain an array of the scintillator crystals, in a specified arrangement, along with photomultiplier tubes. As in the case of well-logging devices, many variations on PET devices are possible.

As also alluded to previously, the light output of the scintillator is very important in a number of the end use applications, such as well-logging and PET technologies. The present invention can provide scintillator materials which possess the desired light output for demanding applications of the technologies. In some instances, the crystals can simultaneously exhibit some of the other important properties noted above, e.g., short decay time, high “stopping power”, and acceptable energy resolution. Furthermore, the scintillator materials can be manufactured economically. They can also be employed in a variety of other devices which require radiation detection.

The addition of gadolinium to scintillator compositions which contain praseodymium and cerium ions appears to improve the light yield associated with the cerium activator. As mentioned above, it is believed that the light yield is enhanced, by way of an energy transfer process, which can be described simply as

Pr⁺³→Gd⁺³→(Gd⁺³)ₙ→Ce⁺³

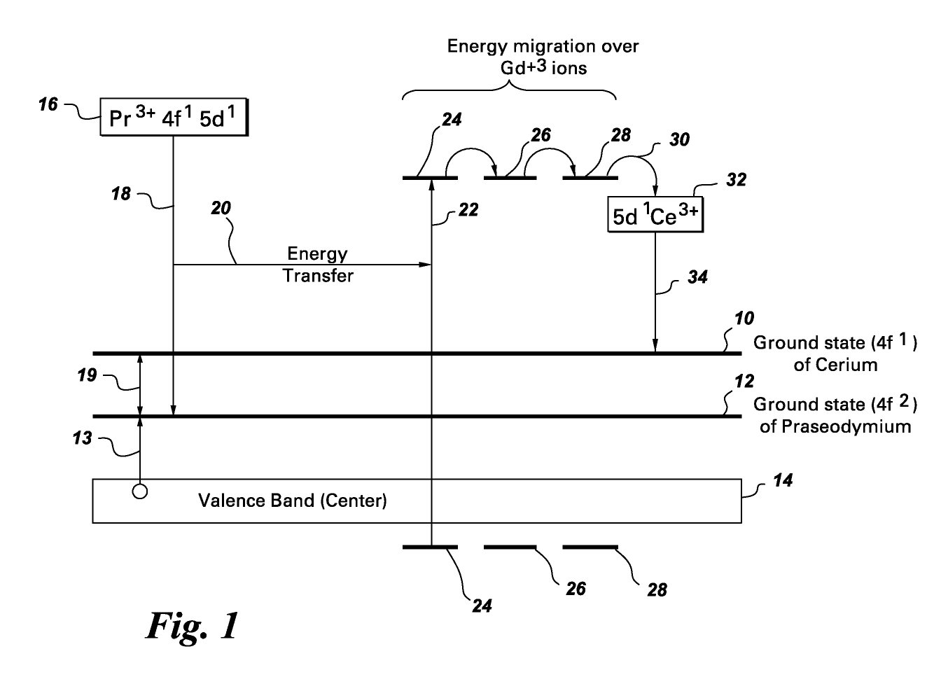

Reference to FIG. 1 is instructive in this regard, wherein the ground state 10 for cerium, and the ground state 12 for praseodymium, are depicted. Typically, the relatively low light yield of many scintillators which employ cerium as the activator ion is attributed to the fact that the cerium ion is inefficient in capturing holes that are formed in the valence band 14, as a result of band gap excitation.

The praseodymium ion is more efficient in “capturing” the valence band holes (see arrow 13). The increased efficiency appears to be due to the fact that the praseodymium ground state 12 is closer to the valence band 14, relative to the cerium ground state 10. The energy difference is indicated by arrow 19.

Praseodymium undergoes emission via the allowed 4f¹5d¹ level 16-to-4f² level 12 (ground state of the praseodymium), shown as an optical transition represented by the arrow 18. If the praseodymium ion emits from the 4f¹5d¹ state (level 16), then energy can be transferred to the cerium ion, thereby improving the light yield (as compared to using cerium by itself). (See, for example, FIG. 1 in U.S. patent application Ser. No. 11/565945, filed on Dec. 1, 2006 (Docket 205891-1), and the accompanying description).

The addition of the gadolinium (Gd) is thought to provide even greater enhancement in light yield, by acting as an intermediate between energy levels associated with the praseodymium and cerium ions. As depicted in simple form in FIG. 1, energy from the praseodymium emission (level 16) is transferred (energy transfer arrow 20) to gadolinium ions, represented in simple form by energy arrow 22. Depending in part on the concentration of gadolinium ions, the emission energy can migrate across Gd energy levels (e.g., levels 24, 26 and 28). As the last step (transfer arrow 30) of this energy transfer process, the migrating energy is captured by cerium ions 32, resulting in enhanced cerium emission (see optical emission arrow 34), and higher light output.

The present inventor emphasizes that the specific mechanism whereby gadolinium enhances the light output of cerium-praseodymium activators is not entirely known. While the theory recited above is plausible, in view of the state of the art and the inventor's own knowledge, other theories may have equal strength in explaining this phenomenon. Thus, the inventor does not want to be bound by all of the aspects of this theory.

### EXAMPLES

The example which follows is merely illustrative, and should not be construed to be any sort of limitation on the scope of the claimed invention. A sample (Lu_{1.975}Ce_{0.01}Gd_{0.005}Pr_{0.01}Si₂O₇) was prepared by combining, in a glove box, 3.7981 grams of lutetium oxide; 0.0166 gram of cerium oxide; 0.0165 gram of praseodymium oxide (Pr₆O₁₁); and 0.0085 gram of gadolinium oxide, with 1.1616 grams of silica (SiO₂), under a slightly-reducing atmosphere (99% N₂ and 1% H₂). After being thoroughly blended, the material was placed in a crucible, and then fired at about 1400° C. for about 10 hours.

Another sample (Lu_{1.98}Ce_{0.01}Pr_{0.01}Si₂O₇) was also prepared according to this general technique, and did not contain any gadolinium. The sample was used for the purpose of comparison. The light yield of each of the samples, under X-ray excitation, was measured under identical conditions.

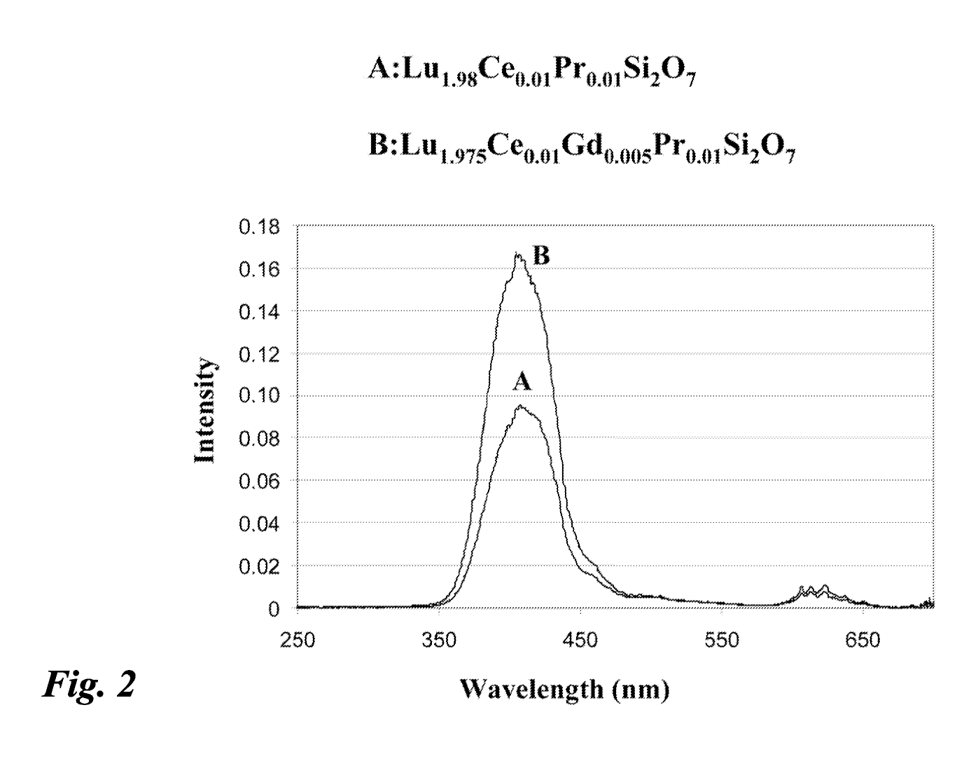

FIG. 2 is a plot of wavelength (nm) as a function of intensity (arbitrary units). Sample A is the Lu_{1.98}Ce_{0.01}Pr_{0.01}Si₂O₇ material, outside the scope of this invention. Sample B is the Lu_{1.975}Ce_{0.01}Gd_{0.005}Pr_{0.01}Si₂O₇ material, within the scope of embodiments of this invention. For each sample, the emission wavelength was about 410 nm. The excitation was carried out with X-ray radiation. The respective curves demonstrate a great improvement in light output (sample B), with the addition of small amounts of gadolinium.

The above description represents some of the embodiments of this invention. However, it will be apparent to those of ordinary skill in this area of technology that other modifications of this invention (beyond those specifically described herein) may be made, without departing from the spirit of the invention. Accordingly, the modifications contemplated by those skilled in the art should be considered to be within the scope of this invention. Furthermore, all of the patents, patent publications, and other references mentioned above are incorporated herein by reference.

What is claimed:

1. A scintillator composition, comprising the following, and any reaction products thereof:
(a) a matrix comprising at least one lutetium silicate or lutetium phosphate compound;
(b) cerium;
(c) praseodymium; and
(d) gadolinium.

2. The scintillator composition of claim 1, wherein cerium is present in a range of from about 0.01 mole percent to about 20 mole percent.

3. The scintillator composition of claim 1, wherein praseodymium is present in a range of from about 0.01 mole percent to about 20 mole percent.

4. The scintillator composition of claim 1, wherein gadolinium is present in a range of from about 0.01 mole percent to about 15 mole percent.

5. The scintillator composition of claim 1, wherein gadolinium is present in a range of from about 0.01 mole percent to about 10 mole percent.

6. The scintillator composition of claim 1, wherein the total amount of cerium, praseodymium, and gadolinium is about 0.01 mole percent to about 20 mole percent, based on total moles of cerium, praseodymium, gadolinium, and the matrix compounds.

7. The scintillator composition of claim 6, having a peak emission wavelength of about 410 nm.

8. The scintillator composition of claim 1, wherein component (a) further comprises one or more additional lanthanides selected from the group consisting of lanthanum, yttrium, gadolinium, terbium, scandium, europium, and mixtures thereof.

9. The scintillator composition of claim 8, wherein the amount of additional lanthanides is up to about 20 mole percent.

10. The scintillator composition of claim 1, wherein the silicate is selected from the group consisting of pyrosilicate (Si₂O₇)⁶⁻, orthosilicate (SiO₄)⁴⁻ and combinations thereof.

11. The scintillator composition of claim 10, wherein the silicate in the matrix (component (a)) comprises lutetium pyrosilicate, Lu₂Si₂O₇.

12. The scintillator composition of claim 1, wherein the matrix comprises lutetium phosphate (LuPO₄).

13. A radiation detector for detecting high-energy radiation, comprising:
(I) a crystal scintillator which comprises the following, and any reaction products thereof:
(a) at least one lutetium silicate or lutetium phosphate compound;
(b) cerium;
(c) praseodymium; and
(d) gadolinium; and
(II) a photodetector optically coupled to the scintillator, so as to be capable of producing an electrical signal in response to the emission of a light pulse produced by the scintillator.

14. The radiation detector of claim 13, wherein
cerium is present in the scintillator, in a range from about 0.01 mole percent to about 20 mole percent;
praseodymium is present in the scintillator, in the matrix, in a range from about 0.01 mole percent to about 20 mole percent; and
gadolinium is present in the scintillator, in a range from about 0.01 mole percent to about 15 mole percent;
wherein the level of each compound is based on the total number of moles of components (a), (b), (c), and (d).

15. The radiation detector of claim 14, wherein the silicate is selected from the group consisting of pyrosilicate (Si₂O₇)⁶⁻, orthosilicate (SiO₄)⁴⁻; and combinations thereof.

16. The radiation detector of claim 15, wherein the silicate comprises lutetium pyrosilicate, Lu₂Si₂O₇.

17. The radiation detector of claim 13, wherein the photodetector is at least one device selected from the group consisting of a photomultiplier tube, a photodiode, a CCD sensor, and an image intensifier.

18. The radiation detector of claim 13, operably connected to a well-logging tool.

19. The radiation detector of claim 13, operably connected to a nuclear medicine apparatus.

20. The radiation detector of claim 19, wherein the nuclear medicine apparatus comprises a positron emission tomography (PET) device.

21. The radiation detector of claim 13, operably connected to a device for detecting the presence of radioactive materials in cargo containers.

22. A method for detecting high-energy radiation with a scintillation detector, comprising the steps of:
(A) receiving radiation by a scintillator crystal, so as to produce photons which are characteristic of the radiation; and
(B) detecting the photons with a photon detector coupled to the scintillator crystal;
wherein the scintillator crystal is formed of a composition comprising the following, and any reaction products thereof:
(a) at least one lutetium silicate or lutetium phosphate compound;
(b) cerium;
(c) praseodymium; and
(d) gadolinium.

23. The method of claim 22, wherein
cerium is present in a range of from about 0.01 mole percent to about 20 mole percent;
praseodymium is present in a range of from about 0.01 mole percent to about 20 mole percent; and
gadolinium is present in a range of from about 0.01 mole percent to about 15 mole percent.

24. The method of claim 22, wherein the silicate (component (B)(a)) is selected from the group consisting of pyrosilicate (Si₂O₇)⁶⁻, orthosilicate (SiO₄)⁴, and combinations thereof.

25. The method of claim 22, wherein the scintillation detector is operably connected to a device selected from the group consisting of a well-logging tool; a nuclear medicine device; and an apparatus for detecting the presence of radioactive materials in cargo containers.
